(19) United States
(12) Patent Application Publication
(10) Pub. No.: US 2009/0034298 A1
(43) Pub. Date: Feb. 5, 2009

(54) Control Method And Apparatus Of Resonant Type DC/DC Converter With Low Power Loss At Light Load And Standby

(75) Inventors: Ta-Kuang Liu, Taipei City (TW); Yu-Chiao Lee, Taoyuan County (TW); Shang-Chin Yen, Taipei County (TW)

Correspondence Address: PERKINS COIE LLP, P.O. BOX 1208, SEATTLE, WA, 98111-1208, US

(73) Assignee: Champion Microelectronic Corporation, Hsinchu (TW)

(21) Appl. No.: 11/830,738

(22) Filed: Jul. 30, 2007

(51) Int. Cl. H02M 3/335

(52) U.S. Cl. 363/17; 363/21.02

(57) ABSTRACT

The present invention discloses a control method and apparatus of resonant converter with low power loss at light load and standby. Based on the frequency response and loading condition of the resonant tank of a resonant converter, adjusts the switching frequency and the switching duty cycle to have a stable output voltage. Perform zero voltage switching and obtain higher converting efficiency by using the energy transfer in the resonant tank of the resonant type converter. Also have higher converting efficiency by combining with synchronize-rectify. Including: a resonant type converter, a controller of resonant type converter, and a regulated voltage mode (frequency modulation hybrid pulse width modulation, FMHYPWM) controller, and if the system specification require, a power factor correction or a double voltage rectifier circuit may be used in the advanced stage of the resonant type converter. The out put rectifier of the resonant type converter may be changed to a synchronized-rectifier.

### BACKGROUND OF THE INVENTION

1. Field of the Invention

The present invention relates to a DC/DC converter. In particular, the present invention relates to a control method and apparatus of resonant type DC/DC converter with higher converting efficiency, good loading regulation and low standby power loss in any loading condition.

2. Description of the Related Art

Since the energy source storage in the world is almost dried up, a common understanding is the development of every kind of energy and economic using of energy. Therefore the developed countries such as European, United States and Japan have legislated against source strategy based on energy performance. The specification of energy loss at standby of the electric products, for example, the “green power”, is mostly keep below 0.5 watt to avoid too much energy consumption of the electric product at standby mode. The foundry of electric product has aimed on the system specification and requirement of the product to develop satisfied products such as low power consumption IC, special function control IC and power supply, etc. Even for high power electric products, has paid much attention on the power loss at light load, for example, the ATX PLUS 80, etc. Some prior art of switching power supply with low power consumption at standby and the technology of related controller will introduce as follow.

FIG. 1 is a block diagram of a switching power supply with low power loss at standby. Generally, it is a cascaded circuit formed by an AC/DC converter unit 11 and a DC/DC converter 12. The AC/DC converter unit 11 may be selected from a rectifier or a double voltage rectifier together with a filter or a power factor modifier in different specifications. It is used to convert the input AC voltage Vac1 into a first DC voltage V_{dc11}. The use of power factor modifier will achieve the power factor to be modified and voltage stabilized of the pre-regulator. The DC/DC converter 12 connected in series with the first stage AC/DC converter 11 is constructed by a fly-back converter, a fly-back converter controller and a standby mode controller. The first DC voltage V_{dc11} of the output from the AC/DC converter unit 11 is converted to the necessary second DC voltage such as 3.3V, 5V, 12V, 24V, 48V or other specified voltages.

The architecture of the DC/DC converter 12 can be an isolated or non-isolated converter. Nowadays, most of the switching power supply is fly-back converter. With its simple structure and low cost, most of the low power product (below 100 watts) is fly-back converter. The other type such as forward converter, active clamp forward converter, or zero voltage switching (ZVS) structure are used in application of lower than 100W.

In the DC/DC converter architecture, the most popular is the fly-back converter. Other than the controller (function) at regular loading condition, Based on the request of “green power”, an extra burst mode is used for control at standby.

FIG. 2 is a schematic diagram of the output voltage vs. system control timing of a switching power supply with low power loss at standby measure from the DC/DC converter under burst standby mode. In the light load or standby condition, besides adjusting the duty cycle to a maximum, also using burst mode to periodically control the conduction of the power transistor. Generally, in the light load or standby condition, with the maximum duty cycle, the DC output voltage V_{dc12} will keep in a range (i.e. between the output upper limit V_{B21} and the output lower limit V_{B22}) within only several cycles. The system will shut down the control signal of the power transistor during the output voltage V_{dc12} is higher than the output upper limit V_{B21}, until the DC output voltage V_{dc12} is lower than the output lower limit V_{B22}, the system again supply the control signal to the power transistor, such that decreasing the switching time of the power transistor and the switching loss of the system under light load and standby condition.

A fly-back converter need an extra snubber to decrease the voltage-spike caused by the oscillation from the leakage inductance and parasitic capacitor. The using of the snubber follow by power loss, and a general snubber without special control or auxiliary switch do not have soft-switching function, the hard-switching of the power transistor also accompanying with power loss. In the traditional architecture, the power loss at standby of the present system is approximately 0.8 W to 1 W. in addition, the use of the burst mode may produce higher audible noise, and the loading stability is worse under this mode, the transition response may become worse. This type is used in products with power lower than 100W.

FIG. 3 is a block diagram of a switching power supply using a burst mode in resonant converter to obtain low power lost at light load and standby. The switching power supply includes a AC/DC converter unit 31 and a burst mode resonant converter 32. The burst mode resonant converter 32 is form by a DC/DC Converter unit, a resonant converter controller and a standby mode controller. The power lost at standby is approximately 0.5 Watt to 0.7 Watt for the existed systems. However, the use of burst mode may produce higher audible noise, and the loading stability is worse under this mode, the transition response may become worse. In burst mode, the switching frequency is operate in very high frequency, it is very difficult to design the main switch of the resonant converter operating in zero voltage switching, so that the switching loss is still not low. Generally, this type is used in products with power lower than 200W.

The above two types of converter is satisfied for low power single output power converter. For high power output condition, design becomes more difficult, and its shortcoming is more serious.

In order to solve the shortcoming, the present invention provides a reasonable design and effectively solves the shortcoming of DC/DC converter control method and apparatus.

### OBJECTS OF THE INVENTION

It is therefore an object of the invention to provide a control method and apparatus of resonant type DC/AC converter by adjust the switching frequency and adjust the switching duty cycle to stabilize the output voltage.

It is another object of the invention to provide a control method and apparatus of resonant type DC/DC converter by using transition of the energy in the resonant tank of the resonant type DC/DC converter to carry out the zero voltage switching to have higher converting effect.

It is yet another object of the invention to provide a control method and apparatus of resonant type DC/DC converter by combining with synchronous rectifier, to have higher converting effect under heavy load current condition.

### DISCLOSURE OF THE INVENTION

A first aspect of the present invention teaches an apparatus of resonant type DC/DC converter with low power loss at light load and standby, from the frequency response of the resonant device and the loading condition of the resonant type converter, implementing a frequency modulation hybrid pulse width modulation (FMHYPWM) to adjust and stabilize the output voltage, and using the energy converting characteristic of the resonant type converter to accomplish zero voltage converting easily at light load and standby, obtain a higher converting efficiency. Under the specification condition of heavily loading output current, by implementing synchronize-rectify to have higher over all converting efficiency. Furthermore, by implementing FMHYPWM, under appropriate occasions, such as at light load or standby, by control the switching type of the resonant type converter to accomplish stable output voltage, fast transition response and low power loss at standby.

The resonant type DC/DC converter includes: (1) An AC/DC converter unit, for converting AC power to DC power, correcting the power factor and pre-regulating the output voltage to output a steady first DC voltage. The AC/DC converter unit is a power factor corrector or a rectifier/double voltage rectifier; (2) A resonant type converter, receiving the first DC voltage from the AC/DC converter unit and converting the first DC voltage into the necessary second DC voltage by adjusting the switching frequency based on the loading to adjusting the second DC voltage; (3) A resonant converter controller, receiving the feedback signal from the output of the resonant converter to adjust the switching frequency and switching duty cycle of the power transistor control signal of the resonant converter to stabilize the output voltage of the system. The resonant type converter is a half bridge resonant converter, a full bridge resonant converter or a single transistor resonant converter, the resonant tank of the resonant converter is a series resonant circuit, a parallel resonant circuit a parallel resonant circuit or a series-parallel resonant circuit; (4) A regulated voltage mode (frequency modulation hybrid pulse width modulation, FMHYPWM) controller, For receiving the control voltage from the VCO (Voltage Control Oscillator) of the resonant converter, output and feedback a control signal to the resonant converter to control the pulse width, i.e. the switching duty cycle of the resonant converter; Thus, by applying an AC voltage to the resonant DC/AC converter with low power loss at standby, a pre-defined second DC voltage can be obtained and effectively lower the power loss upon different loading condition.

A second aspect of the present invention teaches a control method of resonant DC/DC converter with low power loss at light load and standby, implementing a resonant type DC/DC converter with low power loss at light load and standby, the resonant type DC/DC converter consists of a power factor corrector, a resonant converter, a resonant converter controller, and a FMHYPWM controller, the FMHYPWM controller includes an error amplifier, including the following steps: (1) Input AC voltage, said AC voltage is transformed into a first DC voltage by a power factor corrector; (2) The first DC voltage is converted into a second DC voltage; (3) If the frequency is lower than the predetermined frequency F₁, i.e. the second DC voltage is higher than a first reference voltage V_{BF} and the control voltage of the voltage control oscillator (VCO) is higher than a second reference voltage V_{BD}, the second DC voltage is feedback to an error amplifier to compare with the first reference voltage V_{BF}, the produced VCO control voltage is than feedback to the resonant converter controller; and the VCO control voltage is feedback to the FMHYPWM controller to compare with the second reference voltage V_{BD}, since the VCO control voltage is higher than the second reference voltage V_{BD}, the FMHYPWM controller will not adjust the switching duty cycle, but the resonant converter will adjust the switching frequency based on the loading condition to control the resonant converter to adjust the second DC voltage; (4) If the frequency is higher than the predetermined frequency F₁, i.e. the second DC voltage is higher than the first reference voltage V_{BF} and the control voltage of the voltage control oscillator (VCO) is lower than the second reference voltage V_{BD}, the second DC voltage is feedback to an error amplifier to compare with the first reference voltage V_{BF}, to produced a VCO control voltage, this VCO control voltage determine the converting frequency, then feedback the VCO control voltage to said FMHYPWM controller to compare with the second reference voltage V_{BD}, the resonant converter controller controls the resonant converter to adjust the converting condition based on the loading, and since the VCO control voltage is lower than the second reference voltage V_{BD}, the FMHYPWM controller will adjust the switching duty cycle to control the resonant converter to adjust the second DC voltage. (5) Repeat the above mixing switching frequency adjusting and switching duty cycle adjusting step to determine the control process, so that the resonant converter will not damage by the high voltage of parallel resonance, and can be operate under low power loss at light load and standby.

### BRIEF DESCRIPTION OF THE DRAWINGS

The foregoing and other advantages of the invention will be more fully understood with reference to the description of the best embodiment and the drawing wherein:

FIG. 1 (prior art) is a block diagram of a switching power supply with low power loss at standby.

FIG. 2 (prior art) is a schematic diagram of the output voltage versus system control timing of a switching power supply with low power loss at standby measure from the DC/DC converter under bust standby mode.

FIG. 3 (prior art) is a block diagram of a switching power supply using a burst mode in resonant converter to obtain low power lost at light load and standby.

FIG. 4 is block diagram of a resonant type DC/DC converter in accordance with one embodiment another embodiment of the present invention.

FIG. 5 is block diagram of a resonant type DC/DC converter in accordance with another embodiment of the present invention.

FIG. 6 is the frequency response of the resonant circuit used in the resonant type DC/DC converter with low power loss at standby in accordance with another embodiment of the present invention.

FIG. 7 is a schematic diagram of the timing duty cycle versus the switching frequency of a resonant type DC/DC converter with low power loss at light load and standby in accordance with another embodiment of the present invention.

FIG. 8 is a schematic diagram of the VCO control voltage versus the switching frequency of a resonant type DC/DC converter with low power loss at light load and standby in accordance with another embodiment of the present invention.

FIG. 9 is the architecture of a resonant type DC/DC converter with low power loss at light load and standby in accordance with another embodiment of the present invention.

FIG. 10 is the architecture of a resonant type DC/DC converter controller in accordance with another embodiment of the present invention.

FIG. 11 is the architecture of a resonant type DC/DC converter controller with FMHYPWM controller in accordance with another embodiment of the present invention.

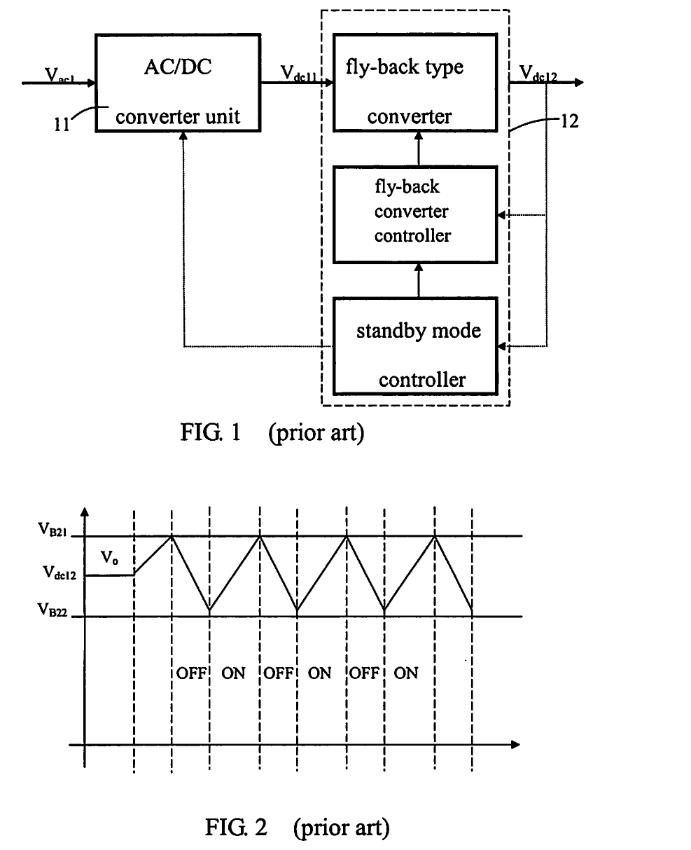

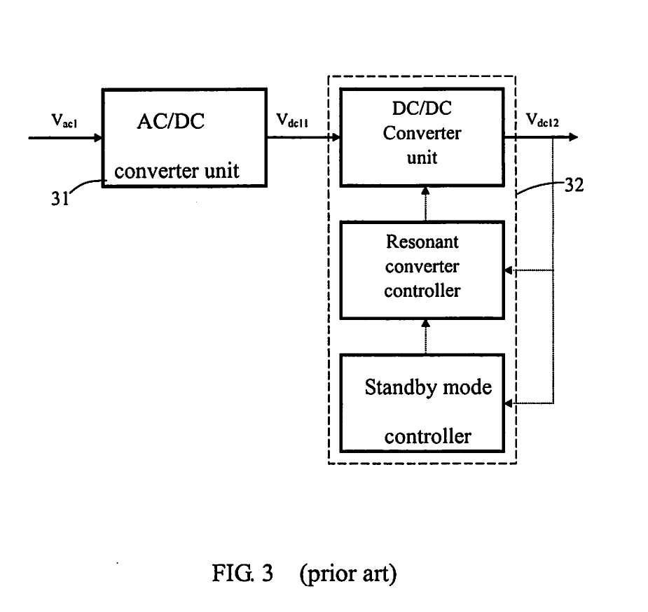

### DESCRIPTION OF THE PREFERRED EMBODIMENTS

The foregoing and other advantages of the invention will be more fully understood with reference to the description of the best embodiment and the drawing as the following description.

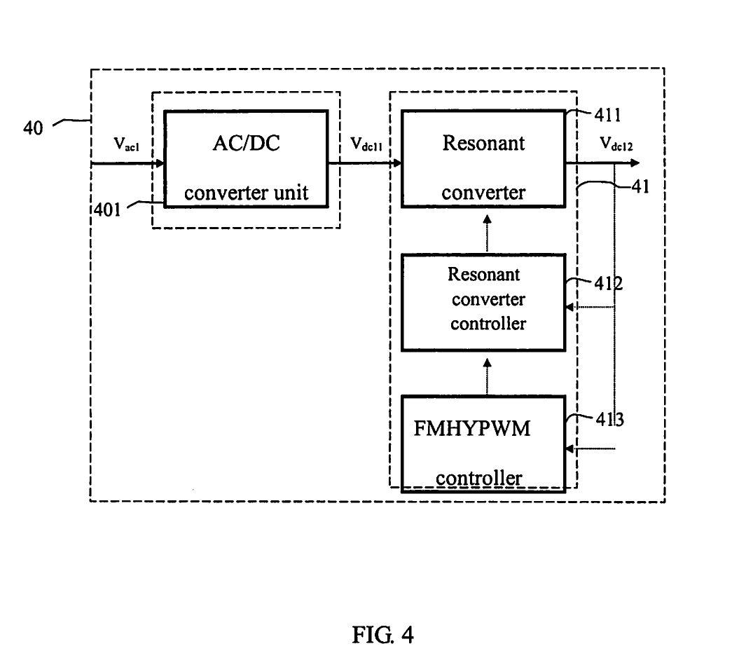

Refer to FIG. 4. FIG. 4 is block diagram of a resonant type DC/DC converter in accordance with one embodiment of the present invention. The resonant type DC/DC converter 40 includes: an AC/DC converter unit 401, a resonant converter 411, a resonant converter controller 412 and a FMHYPWM controller 413. The technical character of the resonant type DC/DC converter is described as follow:

An AC voltage V_{ac1} is applied to the AC/DC converter unit 401, after converts the AC power to a DC power, corrects the power factor and pre-regulating the output voltage to a steady first DC voltage, then a steady first DC voltage V_{dc11} is output to the resonant type converter 411 of a DC/DC converter 41, the resonant type converter 411 converts the first DC voltage V_{dc11} to a necessary second DC voltage V_{dc12}, the resonant type converter controller 412 adjusts the switching frequency of the resonant type converter 411 based on the loading to adjusting and stabilizing the second DC voltage V_{dc12}. The FMHYPWM controller 413 receives the control voltage V_{vco} of the voltage control oscillator (VCO) of the resonant type converter controller 412 to compare with V_{BD}, then controls the switching duty cycle to control the function of the resonant type converter controller 412 and the resonant type converter 411.

Wherein the resonant tank of the resonant converter controller 412 is a series resonant circuit, a parallel resonant circuit or a series-parallel resonant circuit based on different voltage and loading condition, the structure of the converter can be a single transistor class E, a Full/Half-bridge or a push-pull converter.

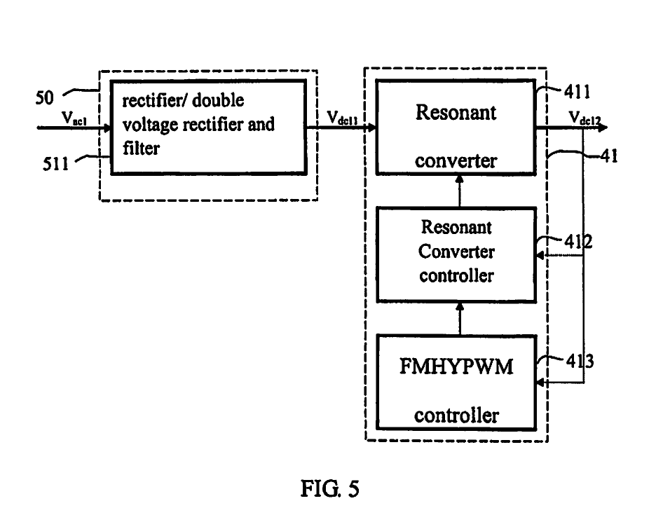

FIG. 5 is block diagram of a resonant type DC/DC converter in accordance with another embodiment of the present invention. The AC/DC converter unit 401 of FIG. 4 is replaced by a rectifier/double voltage rectifier and a filter 511, the other are the same as FIG. 4.

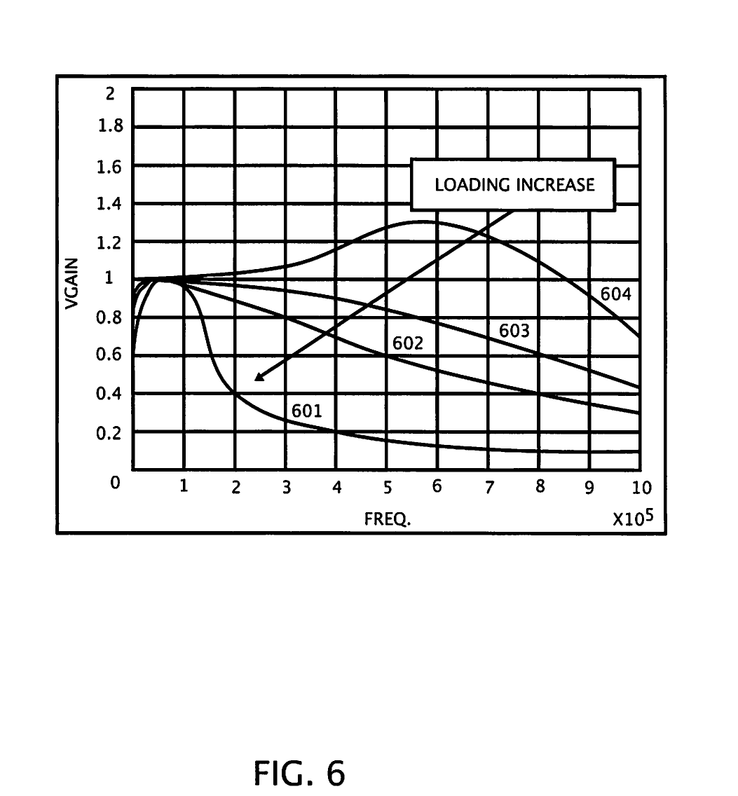

Refer to FIG. 6. FIG. 6 is a plot of frequency response of the resonant circuit used in the resonant DC/DC converter with low power loss at light load and standby in accordance with another embodiment of the present invention. The x-axis is the frequency in 10⁵ Hz. The y-axis is the relative voltage gain. From the figure, at heavy loading, as shown in curve 601, the voltage gain is decreasing at high frequencies, and the voltage gain will increase while the load is decreasing, as shown in curves 602 and 603. Now the switching frequency must be increase to keep the output steady. If the loading is lighter, as shown in curve 604, when the frequency is lower than 7×10⁵ Hz, the voltage gain approach 1, resulting parallel resonance. So that the switching frequency must be higher than 7×10⁵ Hz to protect the circuit, in practice, it is very difficult to design the circuit with switching frequency higher than 7×10⁵ Hz. (FIG. 6 is used for explanation only. The practical range of the operating switching frequency is based on the effects of the loading condition and the real devices).

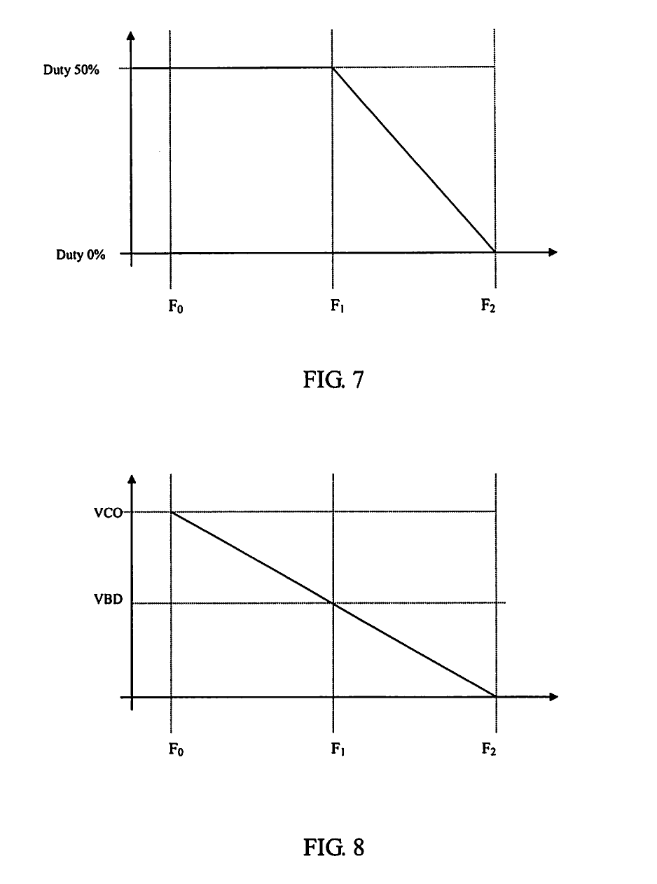

Refer to FIG. 7. FIG. 7 is a schematic diagram of the timing duty cycle versus the switching frequency of a resonant DC/DC converter with low power loss at light load and standby in accordance with another embodiment of the present invention. With frequency between F₀ and F₁, the duty cycle keep on 50%, but with switching frequency between F₁ and F₂, the duty cycle is linearly decreasing from 50% of F₁ to 0% of F₂.

Refer to FIG. 8. FIG. 8 is a schematic diagram of the VCO control voltage versus the switching frequency of a resonant type DC/DC converter with low power loss at light load and standby in accordance with another embodiment of the present invention. The VCO control voltage is linearly decreasing from V_{VC0} of F₀ to 0 of F₂, at F₁, V_{VC0}=V_{BD}. The FMHYPWM controller 413 uses the VCO control voltage as a comparing number, by using the error amplifier in the FMHYPWM controller 413, there are two different operation styles, describe as follow: (wherein the output voltage Vₒ=V_{dc12}, V_{BF} is the first reference voltage, V_{BD} is the second reference voltage).

Vₒ>V_{BF},V_{VC0}>V_{BF}: (1)

Refer to FIG. 7. If the system is operating in ordinary condition, the output can be control stably in a range, the circuit of the resonant type converter 411 is operating by adjusting the switching frequency. The adjusting range is from F0 to F1. Input an AC voltage, the power factor corrector of the AC/DC converter unit converts the AC voltage into a first DC voltage; the resonant type converter converts the first DC voltage to a second DC voltage; the second DC voltage is feedback to a resonant type converter controller 412; the VCO control voltage of the resonant type converter to the FMHYPWM controller 413, so that the FMHYPWM controller 413 adjust the resonant type converter based on the adjusting condition to adjust the second DC voltage. This shows how a designer design the frequency adjusting range based on loading condition.

Vₒ>V_{BF},V_{VC0}<VBF: (2)

Refer to FIG. 7 and FIG. 8. If the output voltage is higher than V_{BF}, and V_{VC0}<V_{BD}, a control signal is then produced by the FMHYPWM controller 413 to control the circuit of the resonant converter 411 adjust with switching duty cycle, and together with adjusting the frequency, as V_{VC0}<V_{BD}, and the larger the different, the smaller the duty cycle of the switching signal of the resonant type converter 411, finally approaching zero. The second DC voltage is feedback to an error amplifier to compare with the first reference voltage V_{BF}, to produced a VCO control voltage, this VCO control voltage determine the converting frequency, then feedback the VCO control voltage to the FMHYPWM controller to compare with the second reference voltage V_{BD}, the resonant type converter controller 412 controls the resonant type converter 411 to adjust the converting condition based on the loading, and since the VCO control voltage is lower than the second reference voltage V_{BD}, the FMHYPWM controller 413 will adjust the switching duty cycle to control the resonant type converter 411 to adjust the second DC voltage. This is the mixing switching frequency adjusting and switching duty cycle adjusting step to determine the control process, so that the resonant converter will not damage by the high voltage of parallel resonance, and can be operate under low power loss at standby.

Under this mode, the frequency adjusting range is between F₁ and F₂, the adjusting duty cycle range is between 50% and 0%, This is the range design by the designer based on the loading condition.

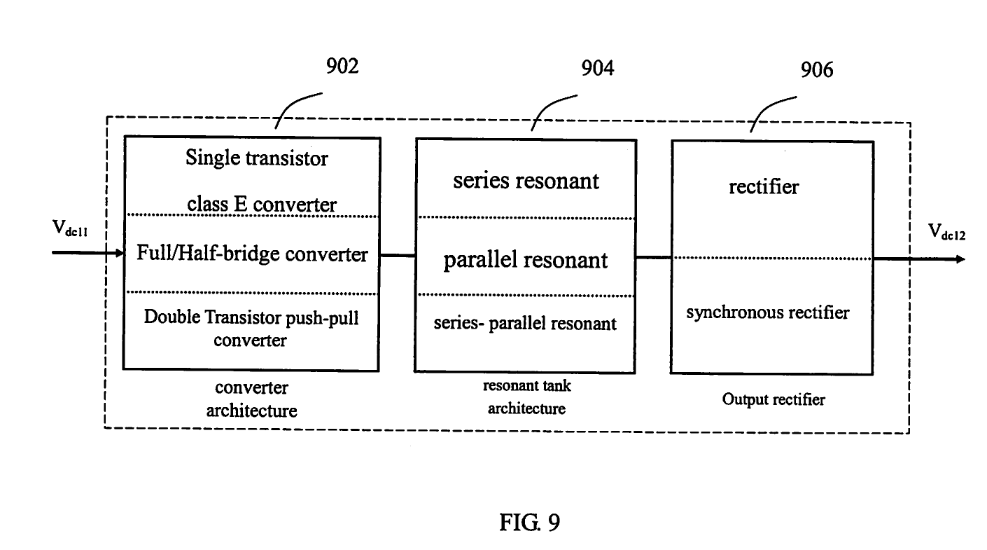

FIG. 9 is the architecture of a resonant DC/DC converter with low power loss at light load and standby in accordance with another embodiment of the present invention. The resonant tank architecture 902 can be classify into series resonant circuit, parallel resonant circuit and series-parallel resonant circuit, The converter architecture 902 is a single transistor class E, a Full/half-bridge converter or a double transistor push-pull converter. Output rectifier 906 is a rectifier or a synchronous rectifier. Under appropriate power circuit parameter design, with the operation of mixing switching frequency adjusting and switching duty cycle adjusting, even under light load or standby condition, zero voltage switching can be obtained. Furthermore, need not add on any extra resonant damping circuit, the system still has very good stable loading regulation, and very low power loss at light load and standby.

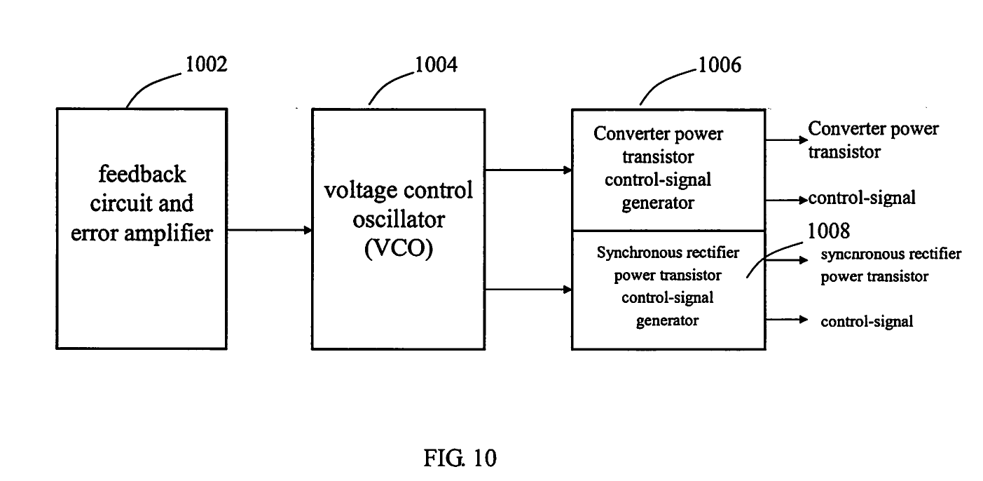

FIG. 10 is the architecture of a resonant DC/DC converter controller in accordance with another embodiment of the present invention. The resonant type DC/DC converter controller is a power transistor control-signal generator with function of voltage control oscillator (VCO), and consists of a feedback circuit and an error amplifier 1002, a voltage control oscillator 1004 and a converter power transistor control-signal generator 1006 or a synchronous rectifier power transistor control-signal generator 1008, to generate converter power transistor control-signal or synchronous rectifier power transistor control-signal. This resonant DC/DC converter controller receives voltage control signal from the feedback circuit to adjust the frequency of the control signal of the power transistor 1102.

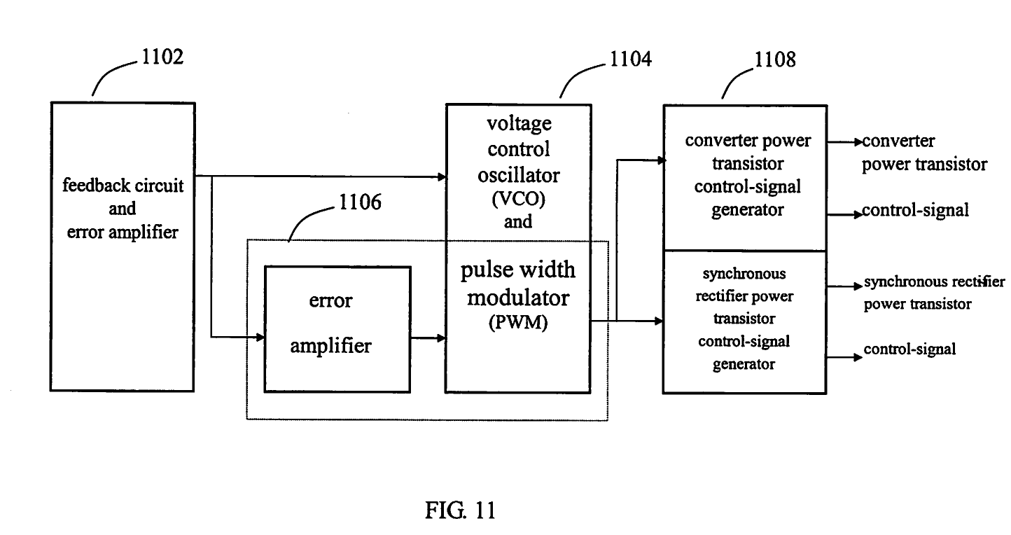

FIG. 11 is the architecture of a resonant DC/DC converter controller with FMHYPWM controller in accordance with another embodiment of the present invention. The FMHYPWM controller is a voltage control signal generator with pulse width modulation (PWM) function, and receives the voltage control signal from the voltage control oscillator to change the duty cycle of the control signal of the resonant type converter controller 412, and consists of a feedback circuit and an error amplifier 1102, a voltage control oscillator (VCO) 1104, an error amplifier and a pulse width modulator (PWM) 1106 and a converter power transistor control-signal generator or a synchronous rectifier power transistor control-signal generator 1108, to generate converter power transistor control-signal or synchronous rectifier power transistor control-signal.

The apparatus and method of resonant DC/DC converter with low power loss at light load and standby by using a resonant converter, even under light load or standby condition, zero voltage switching can be obtained. The switching loss can be decreased under regular operation. Also by mixing switching frequency adjusting and switching duty cycle adjusting step to determine the control process under different loading conditions to improve the loading stability, decrease audible noise and power loss at standby. Furthermore, need not add on any extra resonant damping circuit, under light load or standby condition, the system is operated in high frequency, the ion loss and switching loss is more less than the prior art.

Although specific embodiments of the invention have been disclosed, it will be understood by those having skill in the art that minor changes can be made to the form and details of the specific embodiments disclosed herein, without departing from the scope of the invention. The embodiments presented above are for purposes of example only and are not to be taken to limit the scope of the appended claims.

What is claimed is:

1. An apparatus of resonant type DC/DC converter with low power loss at light load and standby, comprising:
an AC/DC converter unit, for converting AC power to DC power, correcting the power factor and pre-regulating the output voltage to output a steady first DC voltage;
a resonant type converter, receiving said first DC voltage from said AC/DC converter unit and converting said first DC voltage into the necessary second DC voltage by adjusting the switching frequency based on the loading to adjusting said second DC voltage;
a resonant type converter controller, receiving the feedback signal from the output of said resonant type converter to adjust the switching frequency and switching duty cycle of the power transistor control signal of said resonant type converter to stabilize the output voltage of the system;
a regulated voltage mode (frequency modulation hybrid pulse width modulation, FMHYPWM) controller, For receiving the control voltage from the VCO (Voltage Control Oscillator) of said resonant converter, output and feedback a control signal to said resonant converter to control the pulse width, i.e. the switching duty cycle of said resonant converter;
thus, by applying an AC voltage to said resonant type DC/AC converter with low power loss at light load and standby, a pre-defined second DC voltage can be obtained and effectively lower the power loss upon different loading condition.

2. An apparatus as recited in claim 1, wherein said AC/DC converter unit is a power factor corrector.

3. An apparatus as recited in claim 1, wherein said AC/DC converter unit is a rectifier/double voltage rectifier and a filter.

4. An apparatus as recited in claim 1, wherein said resonant type converter is a half bridge resonant converter.

5. An apparatus as recited in claim 1, wherein said resonant type converter is a full bridge resonant converter.

6. An apparatus as recited in claim 1, wherein said resonant converter is a one chip resonant converter.

7. An apparatus as recited in claim 1, wherein the resonant tank of said resonant converter is a series resonant circuit.

8. An apparatus as recited in claim 1, wherein the resonant tank of said resonant converter is a parallel resonant circuit.

9. An apparatus as recited in claim 1, wherein the resonant tank of said resonant converter is a series-parallel resonant circuit.

10. A control method of resonant type DC/DC converter with low power loss at light load and standby, implementing a resonant type DC/DC converter with low power loss at light load and standby, said resonant type DC/DC converter consists of a power factor corrector, a resonant converter, a resonant converter controller, and a FMHYPWM controller, comprising the following steps:
input an AC voltage, said AC voltage is transformed into a first DC voltage by a power factor corrector;
said first DC voltage is converted into a second DC voltage;
if the frequency is lower than the predetermined frequency F₁, i.e. said second DC voltage is higher than a first reference voltage V_{BF} and the control voltage of the voltage control oscillator (VCO) is higher than a second reference voltage V_{BD}, said second DC voltage is feedback to an error amplifier to compare with said first reference voltage V_{BF}, the produced VCO control voltage is than feedback to said resonant converter controller; and said VCO control voltage is feedback to said FMHYPWM controller to compare with said second reference voltage V_{BD}, since the VCO control voltage is higher than the second reference voltage V_{BD}, said FMHYPWM controller will not adjust the switching duty cycle, but the resonant converter will adjust the switching frequency based on the loading condition to control the resonant converter to adjust the second DC voltage;
if the frequency is higher than the predetermined frequency F₁, i.e. said second DC voltage is higher than the first reference voltage V_{BF} and the control voltage of the voltage control oscillator (VCO) is lower than the second reference voltage V_{BD}, said second DC voltage is feedback to an error amplifier to compare with said first reference voltage V_{BF}, to produced a VCO control voltage, this VCO control voltage determine the converting frequency, then feedback said VCO control voltage to said FMHYPWM controller to compare with said second reference voltage V_{BD}, said resonant converter controller controls said resonant converter to adjust the converting condition based on the loading, and since the VCO control voltage is lower than the second reference voltage V_{BD}, said FMHYPWM controller will adjust the switching duty cycle to control said resonant converter to adjust the second DC voltage.
Repeat the above mixing switching frequency adjusting and switching duty cycle adjusting step to determine the control process, so that said resonant converter will not damage by the high voltage of parallel resonance, and can be operate under low power loss at light load and standby.

11. A control method as recited in claim 10, wherein said FMHYPWM controller includes an error amplifier.
